(19) United States
(12) Patent Application Publication
(10) Pub. No.: US 2026/0356072 A1
(43) Pub. Date: Nov. 12, 2026

(54) COMPOSITE PANEL DEVICE AND METHOD OF MAKING THE SAME

(71) Applicant: XXENTRIA TECHNOLOGY MATERIALS CO., LTD., Tainan City (TW)

(72) Inventors: Hsien-Te CHENG, Tainan City (TW); Hsien-Sung CHENG, Tainan City (TW)

(21) Appl. No.: 19/336,207

(22) Filed: Sep. 22, 2025

(30) Foreign Application Priority Data
May 7, 2025 (TW) 114117193

(51) Int. Cl. B32B 3/04; B32B 3/30; B32B 7/12; B32B 15/04; B32B 37/06; B32B 37/08; B32B 37/10; B32B 37/12; B32B 38/00; B32B 43/00

(52) U.S. Cl. CPC B32B 3/04; B32B 3/30; B32B 7/12; B32B 15/043; B32B 37/06; B32B 37/08; B32B 37/10; B32B 37/1284; B32B 38/0004; B32B 43/003; B32B 2307/7375; B32B 2309/14; B32B 2605/003

(57) ABSTRACT

A composite panel device includes a core panel including two core panel surfaces, and two metal panel assemblies that include a first metal panel member, a second metal panel member, a first adhesive layer, and a second adhesive layer. The first metal panel member has a first main panel portion, a first overlap panel portion, and a first connecting panel portion. The second metal panel member has a second overlap panel portion that is adhered to the first overlap panel portion, and a second main panel portion. The first adhesive layer covers the core panel surfaces and adheres the first metal panel member to the core panel surface, and the second main panel portion to the core panel surfaces. The second adhesive layer adheres the first overlap panel portion and the second overlap panel portion. A method of making the composite panel device is also included.

### CROSS-REFERENCE TO RELATED APPLICATION

This application claims priority to Taiwanese Invention Patent Application No. 114117193, filed on May 7, 2025, the entire disclosure of which is incorporated by reference herein.

### FIELD

The disclosure relates to a composite panel, and more particularly to a composite panel device usable for installing a rear storage compartment on a vehicle and a method of making the composite panel device.

### BACKGROUND

Referring to FIGS. 1 and 2, a conventional composite panel device includes three panel body units 9 that are spliced together, whereby one panel body unit 9 is adhered onto another one end-to-end along a front-rear direction. Each of the panel body units 9 includes a core panel 91 that is located at a central portion of the panel body unit 9 and that is made of polyethylene, two metal panels 92 that are respectively adhered to two opposite sides of the core panel 91, and two adhesive layers 93 that are each used to adhere one of the metal panels 92 to the core panel 91.

The metal panels 92 are steel panels, and each of the metal panels 92 includes a main panel portion 921 that is adhered to the core panel 91. Each of the metal panels 92 further includes at least one adhering panel portion 922 that extends from the main panel portion 921 and that protrudes from an end of the core panel 91 of the same panel body unit 9. The adhering panel portion 922 of each metal panel 92 is used to adhere with the main panel portion 921 on another metal panel 92 so that two different panel body units 9 may be spliced together.

However, most commercially available metal panels have maximum width restrictions. Furthermore, the conventional composite panel devices are usually produced to fit into cargo holds of cargo vehicles that have greater width requirements. Therefore, in order to satisfy these requirements, when making the conventional composite panels, a plurality of the panel body units 9 that are of shorter length are first made and then they are spliced together to form a longer conventional composite panel device. The conventional composite panel device thus cannot be made as a single lengthier piece that satisfies cargo hold requirements but must be formed by splicing together multiple panel body units 9. Due to the requirement of splicing together multiple panel body units 9 a longer production cycle is needed for manufacturing the conventional composite panel device because the adhesive used to splice the panel body units 9 together need a lot of time for drying. Additionally when drying the spliced panel body units 9 more space at the manufacturing facility must be provided. Therefore, the conventional composite panel device has a complicated production process and should be improved.

### SUMMARY

Therefore, an object of the disclosure is to provide a composite panel device and a method of making a composite device that can alleviate at least one of the drawbacks of the prior art.

According a first aspect of the disclosure, the composite panel device includes a core panel, and two metal panel assemblies. The core panel includes two core panel surfaces that are located opposite to each other. The two metal panel assemblies are respectively disposed on the two core panel surfaces of the core panel. Each of the metal panel assemblies includes a first metal panel member, a second metal panel member, a first adhesive layer, and a second adhesive layer. The first metal panel member has a first main panel portion that is adhered to the respective one of the core panel surfaces of the core panel, a first overlap panel portion, and a first connecting panel portion that interconnects and bendingly extends between the first main panel portion and the first overlap panel portion. The second metal panel member is disposed on the respective one of the core panel surfaces, and has a second overlap panel portion that is stacked on and adhered to the first overlap panel portion, and a second main panel portion that extends from the second overlap panel portion and that is adhered to the respective one of the core panel surfaces of the core panel. The first overlap panel portion of the first metal panel member is adhered between the respective one of the core panel surfaces and the second metal panel member. The first adhesive layer covers the respective one of the core panel surfaces of the panel, adheres the first metal panel member to the respective one of the core panel surfaces, and adheres the second main panel portion of the second metal panel member to the respective one of the core panel surfaces of the core panel. The second adhesive layer is disposed between and adhering together the first overlap panel portion of the first metal panel member and the second overlap panel portion of the second metal panel member.

According to another aspect of the disclosure, the method of making the composite panel device includes steps of: (A) feeding a core panel material in a feeding direction; (B) feeding two first adhesive tapes in the feeding direction and respectively laying the two first adhesive tapes on the two core material surfaces of the core panel material that are opposite to each other, each of the first adhesive tapes fully covering a respective one of the core material surfaces; (C) feeding two first metal tapes in the feeding direction and respectively laying the two first metal tapes on the two first adhesive tapes, each of the two first metal tapes having a width dimension that is less than a core material width dimension of the core panel material so that each of the first adhesive tapes is partially covered by a respective one of the two first metal tapes and has an uncovered portion; (D) feeding two second metal tapes in the feeding direction, and respectively laying the two second metal tapes on the uncovered portions of the two first adhesive tapes, while at the same time causing the two second metal tapes to respectively overlap with the two first metal tapes each of the two second metal tapes having a width dimension that is less than the core material width dimension of the core panel material; (E) feeding two second adhesive tapes in the feeding direction so that each of the second adhesive tapes bonds overlapping parts of the respective one of the first metal tapes and the respective one of the second metal tapes; (F) heating and compression bonding the core panel material, the first adhesive tapes, the first metal tapes, the second adhesive tapes, and the second metal tapes together; and (G) cutting the core panel material, the first adhesive tapes, the first metal tapes, the second adhesive tapes, and the second metal tapes to form the composite panel device.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is perspective view illustrating a conventional composite panel device that is in an assembled state.

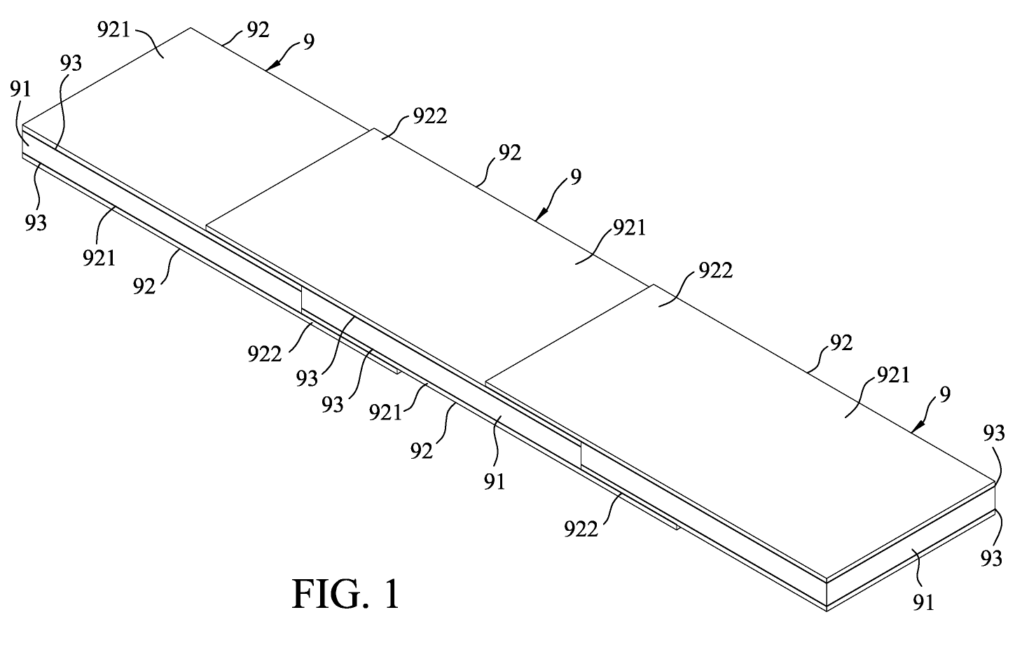

FIG. 2 is a fragmentary cross-sectional view illustrating the conventional composite panel device.

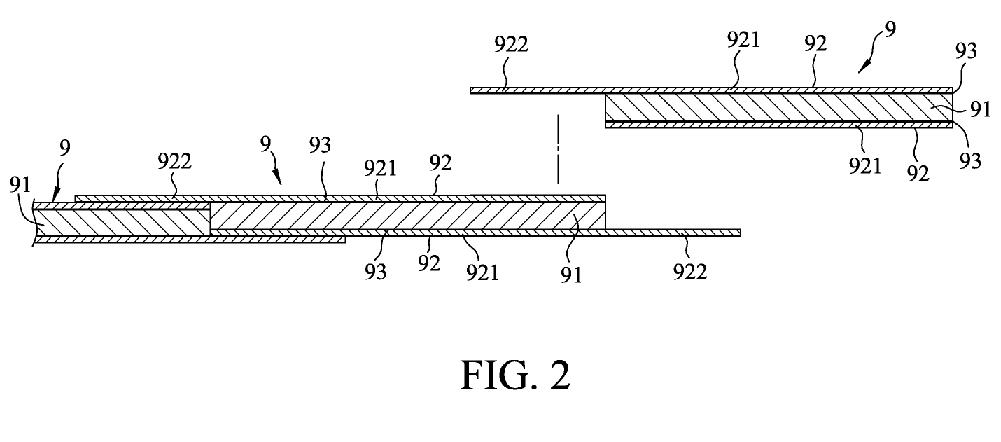

FIG. 3 is a fragmentary perspective view illustrating a first embodiment of a composite panel device according to the present disclosure.

FIG. 4 is a fragmentary cross-sectional view illustrating the first embodiment of the composite panel device.

FIG. 5 is a fragmentary cross sectional enlarged view illustrating the first embodiment of the composite panel device.

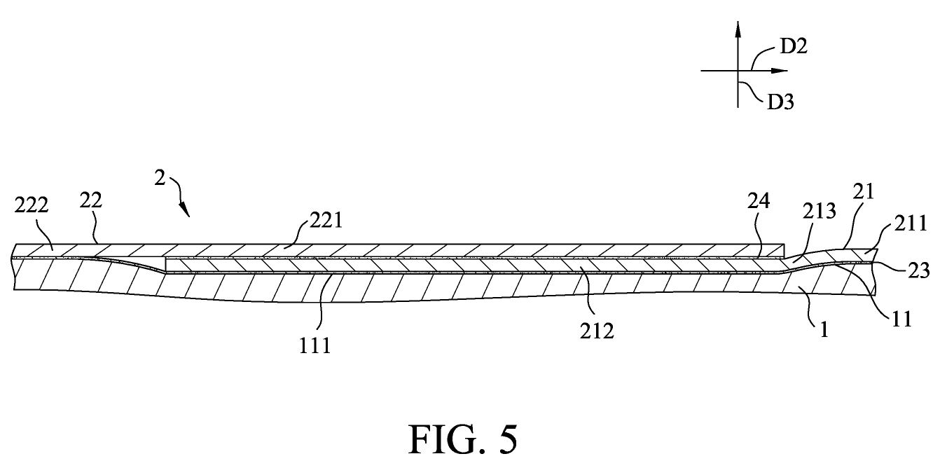

FIG. 6 is a schematic side view illustrating the first embodiment of the composite panel device used in a vehicle.

FIG. 7 is a block diagram illustrating steps in a first embodiment of a method of making a composite panel device.

FIG. 8 is a schematic perspective view illustrating the first embodiment of the method of making the composite panel device.

FIG. 9 is a schematic top view illustrating the first embodiment of the method of making the composite panel device.

FIG. 10 is a schematic side view illustrating the first embodiment of the method of making the composite panel device.

FIG. 11 is a schematic side view illustrating a second embodiment of the method of making the composite panel device.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

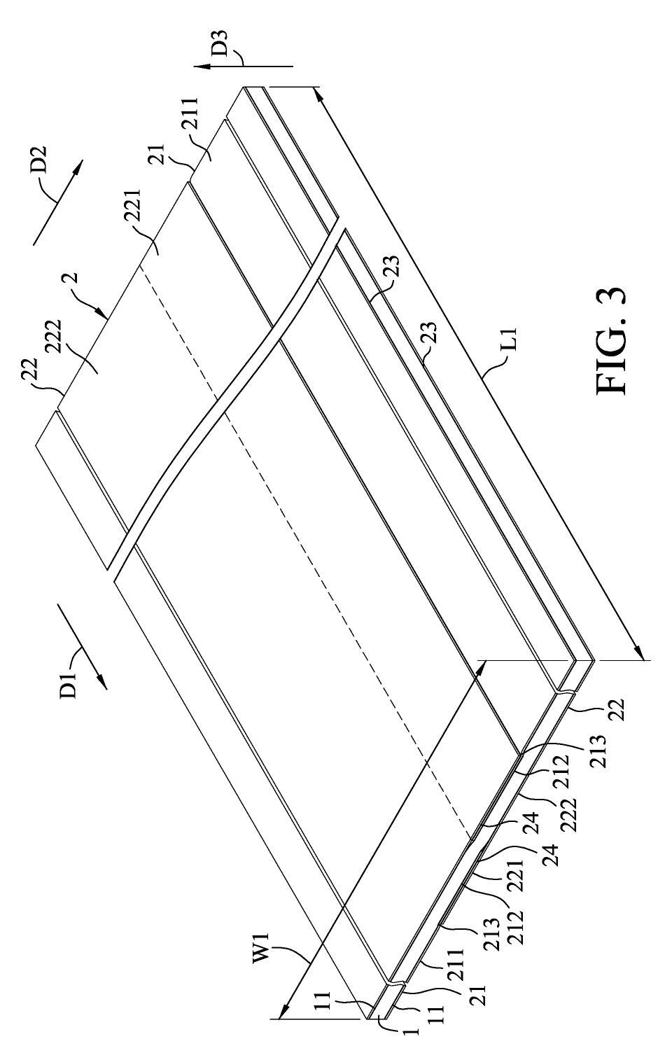

Referring to FIGS. 3 - 5, a first embodiment of a composite panel device according to the present disclosure includes a core panel 1, and two metal panel assemblies 2. The composite panel device defines a length direction (D1) and a width direction (D2).

The core panel 1 may be made of polyethylene, and has a core length dimension (L1) in the length direction (D1), and a core width dimension (W1) in the width direction (D2). In this embodiment, the core length dimension (L1) of the core panel 1 is no less than 1.8 meters and no greater than 10 meters. For example, in different embodiments, the core length dimension (L1) of the core panel 1 may be 2, 3, 4, 5, 6, 7, 8, or 9 meters. The core panel 1 includes two core panel surfaces 11, and two opposite edge faces 12. The two core panel surfaces 11 are located opposite to each other in a stacking direction (D3) that is perpendicular to the length direction (D1) and the width direction (D2). The two opposite edge faces 12 each interconnects the two core panel surfaces 11. Each of the core panel surfaces 11 has a recessed surface portion 111 that is recessed toward another one of the core panel surfaces 11 and that is intermediate between the edge faces 12.

The two metal panel assemblies 2 are respectively disposed on the two core panel surfaces 11 of the core panel 1. The two metal panel assemblies 2 and the core panel 1 are stacked along the stacking direction (D3). Each of the metal panel assemblies 2 includes a first metal panel member 21, a second metal panel member 22, a first adhesive layer 23, and a second adhesive layer 24.

The first metal panel member 21, and the second metal panel member 22 of each of the metal panel assemblies 2 are adhered to the respective one of the core panel surfaces 11 of the core panel 1. The first adhesive layer 23 is disposed between the first metal panel member 21 and the respective one of the core panel surfaces 11, and the second metal panel member 22 and the respective one of the core panel surfaces 11. The second adhesive layer 24 is disposed between the first panel member 21 and the second panel member 22.

Each of the first metal panel members 21 has a surface area that is less than a surface area of the respective one of the core panel surfaces 11 of the core panel 1, and does not extend past the edge faces 12 of the same core panel 1. Each of the first metal panel members 21 has a length that is the same as the core panel 1, and has a first width dimension (W21) along a direction that is parallel to the core width dimension (W1). In some embodiments, the first panel width dimension (W21) of each of the first metal panel members 21 is no less than 0.9 meters and no greater than 1.5 meters. For example, in different embodiments, the first panel width dimensions (W21) may be 1, 1.1, 1.2, 1.3, or 1.4 meters.

The first metal panel member 21 of each of the metal panel assemblies 2 has a first main panel portion 211, a first overlap panel portion 212, and a first connecting panel portion 213. The first main panel portion 211 is adhered to the respective one of the core panel surfaces 11 of the core panel 1 via the first adhesive layer 23. The first overlap panel portion 212 is adhered to the second panel member via the second adhesive layer 24, and adhered to the respective one of the core panel surfaces 11 via the first adhesive layer 23. The first connecting panel portion 213 interconnects and bendingly extends between the first main panel portion 211 and the first overlap panel portion 212. The first main panel portion 211 and the first overlap panel portion 212 of the same first metal panel member 21 are spaced apart in the width direction (D2). The first overlap panel portion 212 is located in the recessed surface portion 111 of the respective one of the core panel surfaces 11. More specifically, the first overlap panel portion 212 of the first metal panel member 21 is adhered between the respective one of the core panel surfaces 11 and the second metal panel member 22, and adhered to the recessed surface portion 111 of the respective core panel surface 11.

In some embodiments, the first panel width dimension (W21) of each of the first metal panel member 21 may be less than the core width dimension (W1) of the core panel 1 but greater than half of the core width dimension (W1) of the core panel 1. In FIG. 3, the first metal panel member 21 of the upper one of the two metal panel assemblies 2 is flush with a left edge of the core panel 1, and the first metal panel member 21 of the lower one of the two metal panel assemblies 2 is flush with the right edge of the core panel 1. The first overlap panel portions 212 of the two metal panel assemblies 2 are offset from each other in the width direction (D2) and in the stacking direction (D3) so that the first overlap panel portions 212 are in a staggered formation. In this way, the first overlap panel portion 212 of one of the two metal panel assemblies 2 does not overlap with the first overlap panel portion 212 of another one of the two metal panel assemblies 2 in the stacking direction (D3). In other embodiments of the disclosure, the first panel width dimension (W21) of the first metal panel member 21 of each of the metal panel assemblies 2 may be less than half of the core width dimension (W1) of the core panel 1. In these cases, the first overlap panel portions 212 of the two metal panel assemblies 2 may also be in a staggered formation with respect to the width direction (D2) and the stacking direction (D3).

The first connecting panel portion 213 connects the first main panel portion 211 and the first overlap panel portion 212 together to form a single contiguous piece. In the first embodiment, the first connecting panel portion 213, the first main panel portion 211, and the first overlap panel portion 212 of the first metal panel member 21 in each of the two metal panel assemblies 2 are made from a single metal panel, which will be described in detail hereinafter. It should be noted that the first connecting panel portion 213 is roll formed from the first metal panel member 21 and only has a slight bend.

The second metal panel member 22 of each of the two metal panel assemblies 2 has a second width dimension (W22) along a direction that is parallel to the core width dimension (W1). In each of the metal panel assemblies 2, the second metal panel member 22 is disposed on the respective one of the core panel surfaces 11, and has a second overlap panel portion 221, and a second main panel portion 222. The second overlap portion 221 is stacked on the first overlap panel portion 212, and adhered to the first overlap panel portion 212 via the second adhesive layer 24. The second main panel portion 222 extends from the second overlap panel portion 221 and is adhered to the respective one of the core panel surfaces 11 of the core panel 1 via the first adhesive layer 23.

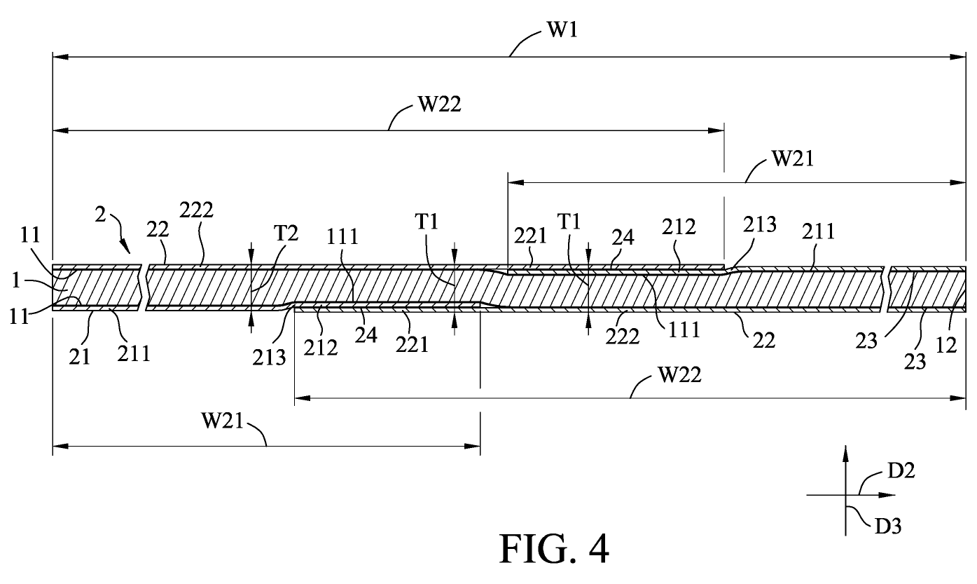

The first metal panel member 21 of each of the metal panel assemblies 2 has a surface area that is smaller than the respective one of the core panel surfaces 11 of the core panel 1, and does not extend beyond either one of the edge faces 12 of the core panel 1. The core width dimension (W1) of the core panel 1 is greater than the second width dimension (W22) of the second metal panel member 22 of each of the metal panel assemblies 2. The second panel width dimension (W22) of the second panel member 22 of each of the two metal panel assemblies 2 is no less than 0.9 meters and no greater than 1.5 meters. For example, the second panel width dimension (W22) may be 1, 1.1, 1.2, 1.3 or 1.4 meters. It should be noted that the second metal panel members 22 of the metal panel assemblies 2 on the same core panel 1 may the same or have different width dimensions (W22) to accommodate different first panel width dimensions (W21) of the first metal panel member 21. In FIG. 4, the second metal panel members 22 on the top and bottom of the core panel 1 have different width dimensions (W22) to accommodate different first width dimensions (W21) of the first metal panel members 21 on top and bottom of the core panel 1.

In this embodiment, the first adhesive layer 23 of each of the metal panel assemblies 2 is a maleic anhydride grafted polyethylene (MAH-g-PE) material. The first adhesive layer 23 covers the respective one of the core panel surfaces 11 of the core panel 1, adheres the first metal panel member 21 and the second metal panel member 22 to the respective one of the core panel surfaces 11. Specifically, the first adhesive layer 23 adheres the second main panel portion 222 of the second metal panel member 22 and to the respective one of the core panel surfaces 11 of the core panel 1, and also adheres all of the first main panel portion 211, the first overlap panel portion 212, and the first connecting panel portion to the respective one of the core panel surfaces 11 of the core panel 1.

In this embodiment, the second adhesive layer 24 of each of the metal panel assemblies 2 is a maleic anhydride grafted polyethylene (MAH-g-PE) material. The second adhesive layer 24 is disposed between and adheres together the first overlap panel portion 212 of the first metal panel member 21 and the second overlap panel portion 221 of the second metal panel member 22.

The composite panel device according to the present disclosure has a first characteristic in that the second metal panel member 22 is directly adhered onto the first metal panel member 21 of the same metal panel assembly 2 where they overlap, and the first metal panel member 21 and the second metal panel member 22 are both adhered to the core panel 1. This makes the process of making the composite panel device simpler (which will be further elucidated in the method of making the composite panel device later in the disclosure).

The composite panel device according to the present disclosure has a second characteristic in that the first overlap panel portions 212 of the first metal panel members 21 of the two metal panel assemblies 2 are arranged in a staggered formation in the width direction (D2) and in the stacking direction (D3). More specifically, for each of the two metal panel assemblies 2, an overlap structure is formed from the first overlap panel portion 212 of the first metal panel portion 21, the second adhesive layer 24, and the second overlap panel portion 221 of the second metal panel member 22. The overlap structures of the two metal panel assemblies 2 are arranged in a staggered formation in the width direction (D2) and the stacking direction (D3). The core panel 1 has a thickness (T1) at a positon corresponding to the overlap structure that is slightly greater than a thickness (T2) at other positions of the core panel 1 where the overlap structure is not present. For example, in this embodiment, the thickness (T1) may be 6.2 millimeters and the thickness (T2) may be 6 millimeters. By having the configuration where the first panel portion 212 of one of the two metal panel assemblies 2 does not overlap the first overlap panel portion 212 of another one of the two metal panel assemblies 2 in the stacking direction (D3), the overall thickness of the composite panel device may be reduced.

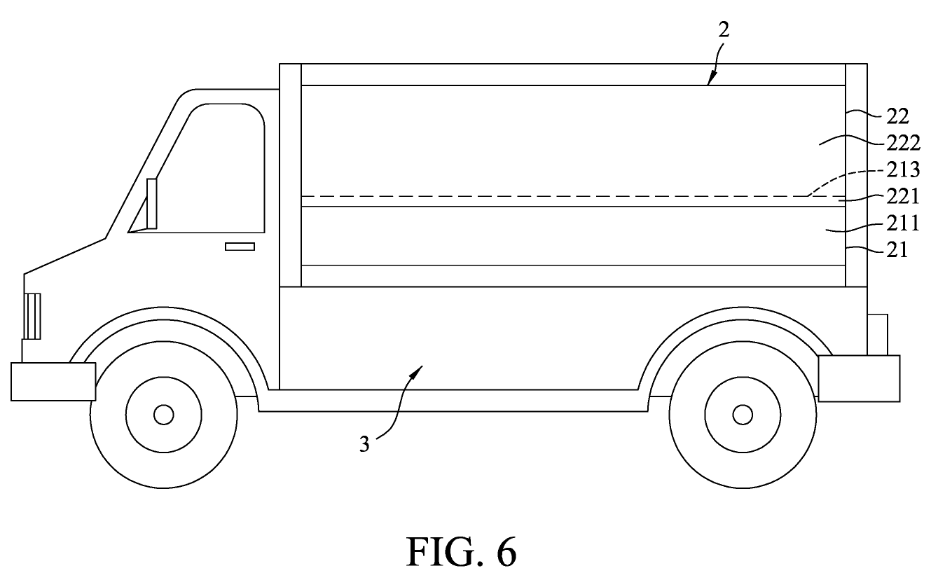

Referring to FIGS. 3, 4, and 6, the composite panel device may be used to install a rear storage compartment 3 on a vehicle. More specifically, multiple composite panel devices may be assembled together to constitute a surrounding wall of the storage compartment 3 of the vehicle. It should be noted that the vehicle storage compartment is not limited to that shown in FIG. 6.

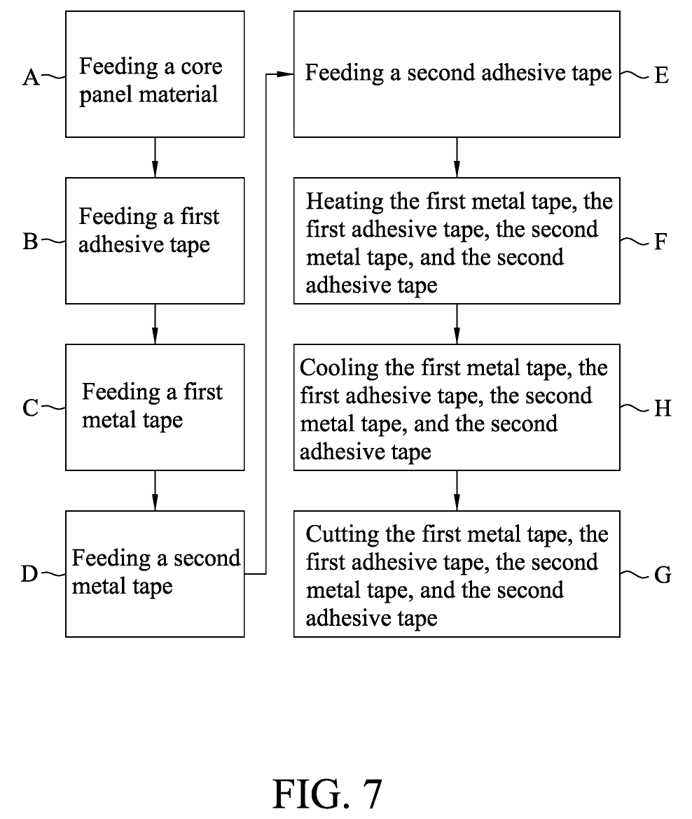

Referring to FIG. 7, a first embodiment of a method (M1) of making a composite panel device according to the present disclosure includes the steps (A) to (G).

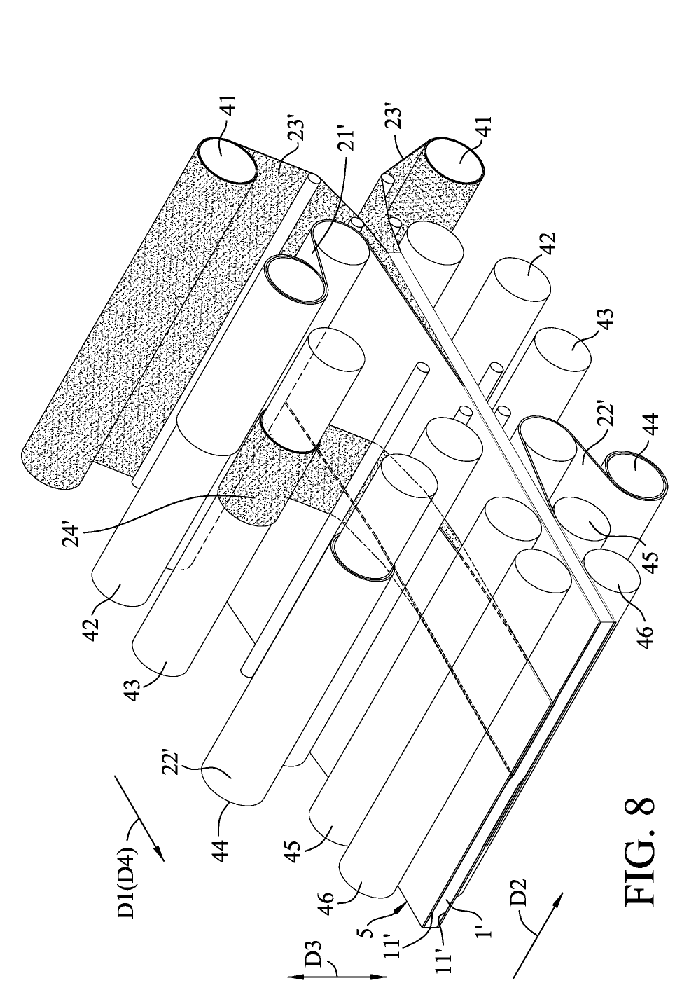

Referring to FIGS. 8 - 10, in a step (A) a core panel material 1’ is fed in a feeding direction (D4) that is the same direction as the length direction (D1). It should be noted that the core panel material 1’ will later be cut to form the core panel 1 in step (G).

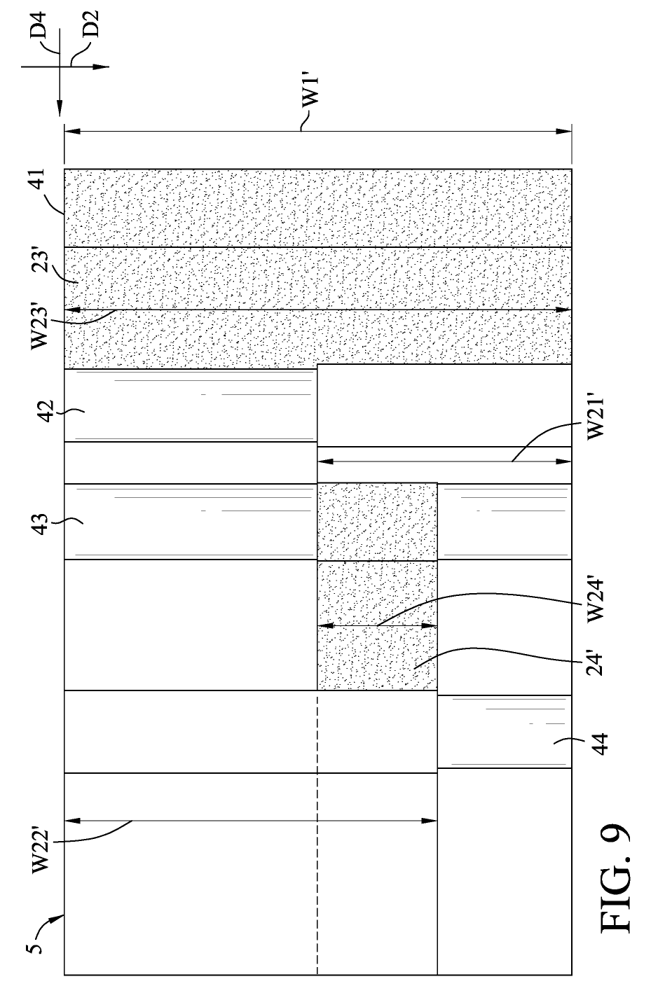

In the step (B) two first adhesive tapes 23’ are fed in the feeding direction (D4). The first adhesive tapes 23’ are respectively laid on two core material surfaces 11’ of the core panel material 1’ that are located opposite to each other. Each of the first adhesive tapes 23’ fully covers a respective one of the core material surfaces 11’. In this embodiment, the first adhesive tapes 23’ are fed via conveyor rollers. Specifically, the first adhesive tapes 23’ are respectively wound onto two first rollers 41 and are then gradually unwound and released onto the core panel material 1’. The adhesive tapes 23’ are later cut in the step (H) to form the first adhesive layer 23 (see FIG. 4). Referring to FIG. 9, in this embodiment, each of the first adhesive tapes 23’ has a first tape width (W23’) that is the same as a core material width dimension (W1’) of the core panel material 1’.

In the step (C), the two first metal tapes 21’ are fed in the feeding direction (D4) and respectively laying the two first metal tapes 21’ on the two first adhesive tapes 23’. Each of the two first metal tapes 21’ has a width dimension (W21’) in the width direction (D2) that is less than the core material width dimension (W1’) so that each of the first adhesive tapes 23’ is partially covered by a respective one of the two first metal tapes 21’ and has an uncovered portion. Each of the two first metal tapes 21’ is rolled onto a second roller 42 that is then gradually unrolled. Furthermore, it should be noted that each of the two first metal tapes 21’ will be cut into individual first metal panel members 21 later in the step (H). In this embodiment, the sum of the width dimensions (W21’) both of the two first metal tapes (21’) is less than the core material width dimension (W1’) of the core panel material 1’. More specifically, the width dimension (W21’) of each of the first metal tapes (21’) is no less than 0.9 meters and no greater than 1.5 meters.

Afterwards, in the step (D), two second metal tapes 22’ are fed in the feeding direction (D3), and respectively laid on the uncovered portions of the two first adhesive tapes 23’, while at the same time the two second metal tapes 22’ are caused to respectively overlap with the two first metal tapes 21’. Each of the two second metal tapes 22’ has a width dimension (W22’) that is less than the core material width dimension (W1’) of the core panel material 1’. More specifically, the width dimension (W22’) each of the two second metal tapes 22’ is no less than 0.9 meters and no greater than 1.5 meters. Each of the two second metal tapes 22’ are rolled onto a fourth roller 44 that is then gradually unrolled. It should be noted that the two second metal tapes 22’ will later be cut in the step (H) to form the metal second metal panel members 22.

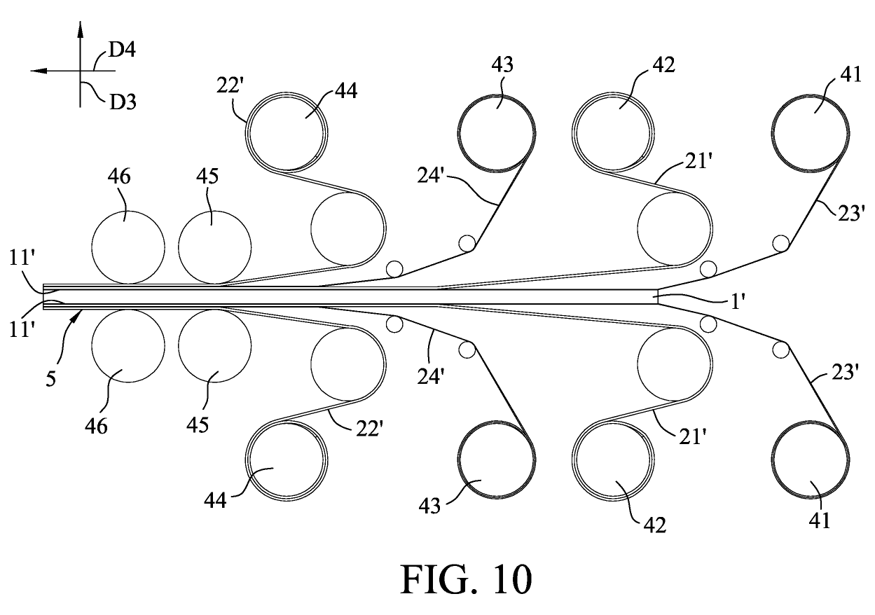

Next, in the step (E), two second adhesive tapes 24’ are fed in the feeding direction (D4) so that each of the second adhesive tapes 24’ is located between and adhered to overlapping parts of the respective one of the first metal tapes 21’ and the respective one of the second metal tapes 22’. In this embodiment, as shown in FIG. 10, the two second adhesive tapes 24’ are respectively first adhered to the two first metal tapes 21’ before the two second metal tapes 22’ are caused to respectively overlap with the first metal tapes 21’ in the step (D). Each of the two second adhesive tapes 24’ is laid on the respective first metal tape 21 at a position that corresponds to a central area of the core panel material 1’. Each of the two second adhesive tapes 24’ is rolled onto a third roller 43’ that is then gradually unrolled. Referring back to FIG. 9, each of the two second adhesive tapes 24’ has a second tape width (W24’) that corresponds to the width of the first overlap panel portion 212 of the first metal panel member 21 and the second overlap panel portion 221 of the second metal panel member 22. More specifically, the second tape width (W24’) of each of the two second adhesive tapes 24’ is no less than 20 millimeters and no greater than 28 millimeters. It should be noted that the second adhesive tapes 24’ will later be cut in the step (H) to respectively form the second adhesive layers 24. By performing steps (A) to (E), the core panel material 1’, the two first metal tapes 21’, the two second metal tapes 22’, the two first adhesive tapes 23’, and the two second adhesive tapes 24’ are integrally formed into a long composite structure 5 which will be tailored later to provide the composite panel device of the disclosure.

In this embodiment of the method of making the composite panel device, the first adhesive tapes 23’, the first metal tapes 21’, the second adhesive tapes 24’, and the second metal tapes 22’ are fed via a plurality of calender rollers. Each of the plurality of calender rollers has a feeding speed ranging from 2 to 4 meters per minute. More specifically, in this embodiment, the first adhesive tapes 23’, the first metal tapes 21’, the second adhesive tapes 24’, and the second metal tapes 22 are respectively fed via calender rollers (only some of the calender rollers are shown at “45” and “46” in FIGS. 8, 10, 11).

Next in the step (F), the core panel material 1’, the first adhesive tapes 23’, the first metal tapes 21’, the second adhesive tapes 24’, and the second metal tapes 22’ are heated and compression bonded together. In this embodiment, in the step (F), two heating calender rollers 45 are heated by a heating means (not shown) for heating the core panel material 1’, each of the first adhesive tapes 23’ and the second adhesive tapes 24’, and to compression bond the core panel material 1’, the first adhesive tapes 23’, the first metal tapes 21’, the second adhesive tapes 24’, and the second metal tapes 22’ together. In this embodiment, the heating calender rollers 45 may provide a heating temperature of 160 °C to 200 °C. When the heating calender rollers 45 are performing heating and compression-bonding, the core panel material 1’, the first metal tapes 21’, and the second metal tapes 22’ will be compacted and squeezed therebetween so that the recessed surface portions 111 of the core panel surfaces 11 are formed in the core panel 1. At the same time, the overlapping portion of each of the first metal tapes 21’ will also be squeezed into the recessed surface portion 111 of the respective core panel surface 11. The overlapping portion of the first metal tape 21’ which is squeezed as described above will form the first connecting panel portion 213 and the first overlap panel portion 212 of the first panel member 21 in the composite panel device of the disclosure.

In this embodiment, the heating calender rollers 45 may provide both heating and compression-bonding functions. However, in other embodiments, these two functions may be provided by separate components. For example, heating may be done by using hot air heating, and compression bonding may be done by non-heated rollers.

The step (H) is a cooling step that is performed before step (G) that is a cutting step. In step (H), the core panel material 1’, the first adhesive tapes 23’, the first metal tapes 21’, the second metal tapes 22’, and the second adhesive tapes 24’ are cooled. This allows the adhesive material in the first adhesive tapes 23’, and the second adhesive tapes 24’ to be cooled after being heated in step (F). Referring to FIGS. 8 and 10, in this embodiment, the cooling is conducted with two cooling calender rollers 46 that are cooled by a cooling means (not shown) and that are used for cooling the first adhesive tapes 23’ and the second adhesive tapes 24’. More specifically, in this embodiment, two cooling calender rollers 46 are used for cooling and two heating calender rollers 45 are used for heating; however, this is not a limitation of the disclosure. In other embodiments, there may be only one cooling roller and one heating roller, or there may be three or more cooling rollers and three or more heating rollers. The rollers 46 have a cooling temperature that ranges from about 40 °C to 80 °C.

Next, in the step (G), the long composite panel structure 5 that is composed of the core panel material 1’, the first adhesive tapes 23’, the first metal tapes 21’, the second adhesive tapes 24’, and the second metal tapes 22’ is tailored or cut to form the composite panel device. More specifically, by performing the cutting in the step (G), the core panel material 1’ becomes the core panel 1, the first adhesive tapes 23’ become the first adhesive layers 23, the second adhesive tapes 24’ become the second adhesive layers 24, the first metal tapes 21’ become the first metal panel members 21, the second metal tapes 22’ become the second metal panel members 22, and the composite panel device is thus formed. The long composite panel structure 5 may be cut at different positions based on the dimensions of the vehicle 3. The composite panel device obtained after cutting the long composite panel structure 5 may have the core panel 1 with a length dimension that is no less than 1.8 meters and no greater than 10 meters. Furthermore, it should be noted that the step (H) of cooling the core panel material 1’, the first adhesive tapes 23’, the first metal tapes 21’, the second metal tapes 22’, and the second adhesive tapes 24’ may be done without using any cooling rollers. In some embodiments, the cooling may be done by natural cooling that also allows the core panel material 1’, the first adhesive tapes 23’, the first metal tapes 21’, the second metal tapes 22’, and the second adhesive tapes 24’ to decrease in temperature before the cutting in the step (G).

In this embodiments, the core panel material 1’ is a continuous long panel material 1’. At the beginning, the core panel material 1’ is fed continuously to move along the feeding direction (D4), and the steps (B) to (E) of the method are then performed on different locations of the core panel material 1’ synchronously while the core panel material 1’ is being fed. In some other embodiments, the core panel material 1’ may be a shorter core panel material 1’. Multiple shorter core panel materials 1’ may be fed in a successive manner, and the steps (B) to (F) of the method may be conducted synchronously on each of the multiple shorter core panel material 1’.

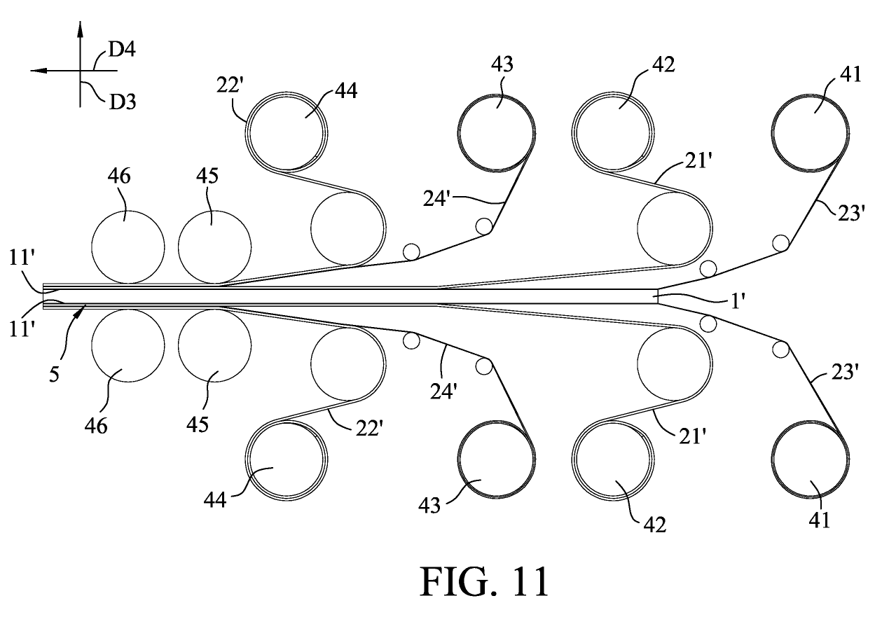

Referring to FIGS. 7 and 11, a second embodiment of the method according to the present disclosure is generally similar to the first embodiment. However, the second embodiment is different to the first embodiment in terms of the step (E). In step (E) of the first embodiment, the second adhesive tapes 24’ are first respectively bonded to the first metal tapes 21’ before being respectively bonded to the second metal tapes 22’, whereas in step (E) of the second embodiment of the method the second adhesive tapes 24’ are first bonded respectively to the second metal tapes 22’ before being respectively bonded to the first metal tapes 21’.

In the method of making the composite panel device according to the present disclosure, the core panel material 1’, the first metal tapes 21’, the second metal tapes 22’, the first adhesive tapes 23’, and the second adhesive tapes 24’ are fed in the feeding direction (D4), and the core panel material 1’, the first metal tapes 21’, the second metal tapes 22’, the first adhesive tapes 23’, and the second adhesive tapes 24’ are bonded together to form the long composite panel structure 5 which may then be tailored and cut to provide the composite panel device with a tailored customized length. The composite panel device of the disclosure and the method of making the composite panel device are beneficial to dispense with tortuous splicing of multiple composite panels that is required in the prior art for providing a composite panel with a desired length. The method of making the composite panel device simplifies production and manufacture of a customized composite panel.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A composite panel device comprising:
a core panel including two core panel surfaces that are located opposite to each other; and
two metal panel assemblies respectively disposed on said two core panel surfaces of said core panel, each of said metal panel assemblies including:
a first metal panel member having a first main panel portion that is adhered to the respective one of said core panel surfaces of said core panel, a first overlap panel portion, and a first connecting panel portion that interconnects and bendingly extends between said first main panel portion and said first overlap panel portion;
a second metal panel member disposed on the respective one of said core panel surfaces, and having a second overlap panel portion that is stacked on and adhered to said first overlap panel portion, and a second main panel portion that extends from said second overlap panel portion and that is adhered to the respective one of said core panel surfaces of said core panel, said first overlap panel portion of said first metal panel member being adhered between the respective one of said core panel surfaces and said second metal panel member;
a first adhesive layer covering the respective one of said core panel surfaces of said core panel, adhering said first metal panel member to the respective one of said core panel surfaces, and adhering said second main panel portion of said second metal panel member to the respective one of the core panel surfaces of said core panel; and
a second adhesive layer disposed between and adhering together said first overlap panel portion of said first metal panel member and said second overlap panel portion of said second metal panel member.

2. The composite panel device as claimed in claim 1, wherein:
said core panel has a core width dimension;
said first metal panel member of each of the metal panel assemblies has a first width dimension along a direction that is parallel to the core width dimension;
said second metal panel member of each of the metal panel assemblies has a second width dimension along a direction that is parallel to the core width dimension; and
said core width dimension is greater than said first width dimension and said second width dimension.

3. The composite panel device as claimed in claim 2, wherein:
said core panel has a core length dimension that is no less than 1.8 meters and no greater than 10 meters;
said first panel width dimension of said first metal panel member of each of said two metal panel assemblies is no less than 0.9 meters and no greater than 1.5 meters;
said second panel width dimension of said second metal panel member of each of said two metal panel assemblies is no less than 0.9 meters and no greater than 1.5 meters.

4. The composite panel device as claimed in claim 1, wherein:
said two metal panel assemblies and said core panel are stacked along a stacking direction;
said first overlap panel portion of one of said two metal panel assemblies does not overlap said first overlap panel portion of another one of said two metal panel assemblies in the stacking direction.

5. The composite panel device as claimed in claim 1, wherein:
said core panel includes two opposite edge faces that each interconnects said two core panel surfaces;
each of said core panel surfaces has a recessed surface portion that is recessed toward another one of said core panel surfaces and that is intermediate between said edge faces; and
said first overlap panel portion of said first metal panel member of each of said two metal panel assemblies is adhered to said recessed surface portion of the respective one of said core panel surfaces.

6. A method of making a composite panel device comprising:
(A) feeding a core panel material in a feeding direction;
(B) feeding two first adhesive tapes in the feeding direction and respectively laying the two first adhesive tapes on two core material surfaces of the core panel material that are opposite to each other, each of the first adhesive tapes covering a respective one of the core material surfaces;
(C) feeding two first metal tapes in the feeding direction and respectively laying the two first metal tapes on the two first adhesive tapes, each of the two first metal tapes having a width dimension that is less than a core material width dimension of the core panel material so that each of the first adhesive tapes is partially covered by a respective one of the two first metal tapes and has an uncovered portion;
(D) feeding two second metal tapes in the feeding direction, and respectively laying the two second metal tapes on the uncovered portions of the two first adhesive tapes, while at the same time causing the two second metal tapes to respectively overlap with the two first metal tapes, each of the two second metal tapes having a width dimension that is less than the core material width dimension of the core panel material;
(E) feeding two second adhesive tapes in the feeding direction so that each of the second adhesive tapes is located between and adheres to overlapping parts of the respective one of the first metal tapes and the respective one of the second metal tapes;
(F) heating and compression bonding the core panel material, the first adhesive tapes, the first metal tapes, the second adhesive tapes, and the second metal tapes together; and
(G) cutting the core panel material, the first adhesive tapes, the first metal tapes, the second adhesive tapes, and the second metal tapes to form the composite panel device.

7. The method of making the composite panel device as claimed in claim 6 further comprising:
(H) cooling the core panel material the first adhesive tapes, the first metal tapes, the second metal tapes, and the second adhesive tapes before performing the step (G).

8. The method of making the composite panel device as claimed in claim 7, wherein the first adhesive tapes, the first metal tapes, the second adhesive tapes, and the second metal tapes are fed via a plurality of calender rollers.

9. The method of making the composite panel device as claimed in claim 7, wherein:
in the step (F), at least one heating calender roller is used to heat the core panel material, each of the first adhesive tapes and the second adhesive tapes, and to compression bond the core panel material, the first adhesive tapes, the first metal tapes, the second adhesive tapes, and the second metal tapes together; and
in the step (H), at least one cooling calender roller is used to cool the first adhesive tapes and the second adhesive tapes.

10. The method of making the composite panel device as claimed in claim 8, wherein each of the plurality of calender rollers has a feeding speed ranging from 2 to 4 meters per minute.

11. The method of making the composite panel device as claimed in claim 6, wherein, in step (E), the two second adhesive tapes are respectively adhered to the two first metal tapes before the two second metal tapes are caused to respectively overlap with the first metal tapes in step (D).

12. The method of making the composite panel device as claimed in claim 6, wherein, in step (E), the two second adhesive tapes are respectively adhered to the two second metal tapes before the two second metal tapes are caused to respectively overlap with the first metal tapes in step (D).

13. A vehicle comprising a storage compartment composed of at least one of said composite panel device as claimed in claim 1.
